(19) United States
(12) Patent Application Publication
(10) Pub. No.: US 2026/0195515 A1
(43) Pub. Date: Jul. 9, 2026

(54) METHOD AND DEVICE FOR OPTIMIZING CIRCUIT DESIGN OF A DIGITAL COMPUTE-IN-MEMORY MACRO

(71) Applicants: The Hong Kong University of Science and Technology, Hong Kong (CN); AI Chip Center for Emerging Smart Systems Limited, Hong Kong (CN)

(72) Inventors: Fengbin TU, Hong Kong (CN); Jia CHEN, Hong Kong (CN); Xiao HUO, Hong Kong (CN); Kwang Ting CHENG, Hong Kong (CN)

(21) Appl. No.: 19/312,409

(22) Filed: Aug. 28, 2025

Related U.S. Application Data
(60) Provisional application No. 63/743,242, filed on Jan. 9, 2025.

(51) Int. Cl. G06F 30/337; G06F 119/06

(52) U.S. Cl. CPC G06F 30/337; G06F 2119/06

(57) ABSTRACT

A computer-implemented method for optimizing circuit design of a digital compute-in-memory (DCIM) macro is disclosed. The method comprises: performing, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to provide a pipeline architecture; performing, based on power-performance-area (PPA) constraints and using a DCIM module library, rapid PPA evaluations on the first design to determine an optimal pipeline architecture for the DCIM macro to obtain a second design thereof; and performing slack-power tuning, based on the second design, on non-critical stages of the DCIM macro defined by the optimal pipeline architecture to obtain a third design of the DCIM macro.

### CROSS REFERENCE TO RELATED APPLICATIONS

The present application claims priority to Provisional Application No. 63/743,242 filed in the U.S. Patent and Trademark Office on Jan. 9, 2025, the entire contents of which are incorporated herein by reference.

### TECHNICAL FIELD

The following relates generally to compute-in-memory (CIM) circuit design and optimization, and more specifically, it relates to a computer-implemented method and related devices for optimizing circuit design of a digital CIM (DCIM) macro.

### BACKGROUND

For completeness, it is hereby clarified that reference made to the definition of format: “[ref. X]” in any paragraph(s) in the description of the present disclosure is to be construed to refer to the corresponding citation “X” in the “References” section of the present disclosure. For example, [ref. 10] refers to citation [10] listed at the “References” section of the present disclosure, while [ref. 4-7] correspondingly refers to citations [4]-[7] mutatis mutandis.

As known in the art, compute-in-memory (CIM) researches tend to usually focus on optimizing energy efficiency, which may be considered more crucial for edge artificial intelligence (AI) scenarios that are concerned with low power and high energy efficiency [ref. 1-4]. However, recent breakthrough in the development and advancement of large language models (LLMs) has resulted in strong demand for high-performance AI accelerators [ref. 5, 6] for training the LLMs. As depicted by various high-performance AI scenarios 100 in FIG. 1, conventional CIM macros typically achieve peak energy efficiency primarily by aggressively lowering voltage, which however requires the operating frequency to be reduced as well (e.g. to smaller than 300 MHz, or even smaller than 100 MHz [ref. 1-4]), and thus may not be suitable for application to high-performance scenarios. It is to be noted that TSMC has successfully applied 2-stage and 3-stage pipeline architectures to digital CIM (DCIM) macros, by segmenting in-memory combinational logic, and presenting the high frequency of pipeline DCIM (e.g. to greater than 1 GHz frequency at high voltages [ref. 7-8]).

However, designing pipeline DCIM for high-performance scenarios generally lacks systematic studies and targeted optimization, which may encounter challenges 105 vis-á-vis register overhead, stage slack, and design tradeoffs (i.e. refer to FIG. 1), which may be explained as:
(1). Use of pipeline registers introduces substantial area overhead in chips, which undesirably increases with stage count.
(2). Since only the critical-path stage determines the highest frequency of a chip, the non-critical stage slack may be leveraged for further power-performance-area (PPA) tuning, without degrading overall chip performance.
(3). Pipeline stage count and position placement significantly affect PPA tradeoffs. Determining the optimal pipeline DCIM architecture for a scenario needs exploration of a large design space, and in this regard, conventional DCIM designs tend to rely heavily on manual efforts, which is needlessly time-consuming and inefficient for design space exploration (DSE).

Accordingly, there is a need for a solution that may address at least one of the problems of the prior art, and/or to provide a choice useful in the art.

### SUMMARY

The described techniques herein may relate to computer-implemented method and related devices for optimizing circuit design of a digital compute-in-memory (DCIM) macro for power, performance and area efficiency.

According to a 1^{st} aspect, there is disclosed a computer-implemented method for optimizing circuit design of a digital compute-in-memory (DCIM) macro, comprises:
performing, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (SAc); performing, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and
performing slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

Additionally or alternatively, the structural parameters may be provided by a designer of the DCIM macro.

Additionally or alternatively, the PPA constraints may be defined by a designer of the DCIM macro.

Additionally or alternatively, wherein performing rapid PPA evaluations on the first design to determine the optimal pipeline architecture may include a number and placement of pipeline stages to be assigned between the plurality of circuit cells.

Additionally or alternatively, wherein the structural parameters include input height (H), weight column (C), minimum data precision (P), and memory compute ratio (R).

Additionally or alternatively, wherein the TSPC-FFs may be configured as 11T dynamic circuit cells.

Additionally or alternatively, the method may further comprise: configuring, based on a process design kit (PDK), a DCIM cell library that includes template designs of SRAMs, full adders, and TSPC-FFs, wherein the PDK is provided by a semiconductor foundry, and includes template designs of standard circuit cells.

Additionally or alternatively, the DCIM module library may be configured based on the PDK and the DCIM cell library.

Additionally or alternatively, wherein the template designs of the SRAMs may include a normal version and a low-power version of said SRAMs, in which relative to the normal version, the low-power version is characterized by a higher threshold voltage (Vt) and a cell structure that is configured with less energy consumption and a longer critical latency.

Additionally or alternatively, wherein the template designs of the full adders may include a normal version and a low-power version of said full adders, in which relative to the normal version, the low-power version is characterized by a higher threshold voltage (Vt) and a cell structure that is configured with less energy consumption and a longer critical latency.

Additionally or alternatively, wherein based on the third design, the DCIM macro may be configured to operate at a maximum frequency range of between 1.03 GHz to 1.40 GHz.

Additionally or alternatively, wherein based on the third design, the DCIM macro may be fabricated by 28 nm CMOS node.

Additionally or alternatively, the method may further comprise: generating, based on the third design of the DCIM macro, a hierarchical schematic design.

Additionally or alternatively, wherein the first design of the DCIM macro may be a baseline design.

According to a 2^{nd} aspect, there is disclosed a computing device for optimizing circuit design of a digital compute-in-memory (DCIM) macro, comprising: one or more memories having executable code; and one or more processors coupled to the one or more memories, and configured to execute the code to cause the device to: perform, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (SAc); perform, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and perform slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

According to a 3^{rd} aspect, there is disclosed a non-transitory computer-readable medium comprising executable code, which when executed by a processor of a computing device, cause the device to perform the method of the 1^{st} aspect.

Additional benefits and advantages of the disclosed aspects may become apparent from the specification and drawings. The benefits and/or advantages may be individually obtained by the various aspects and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various aspects and to explain various principles and advantages in accordance with the present disclosure.

FIG. 1 depicts example high-performance AI scenarios that raise demand for pipeline digital compute-in-memory (DCIM), with challenges arising vis-à-vis design tradeoff, register overhead, and stage slack, in accordance with the prior art.

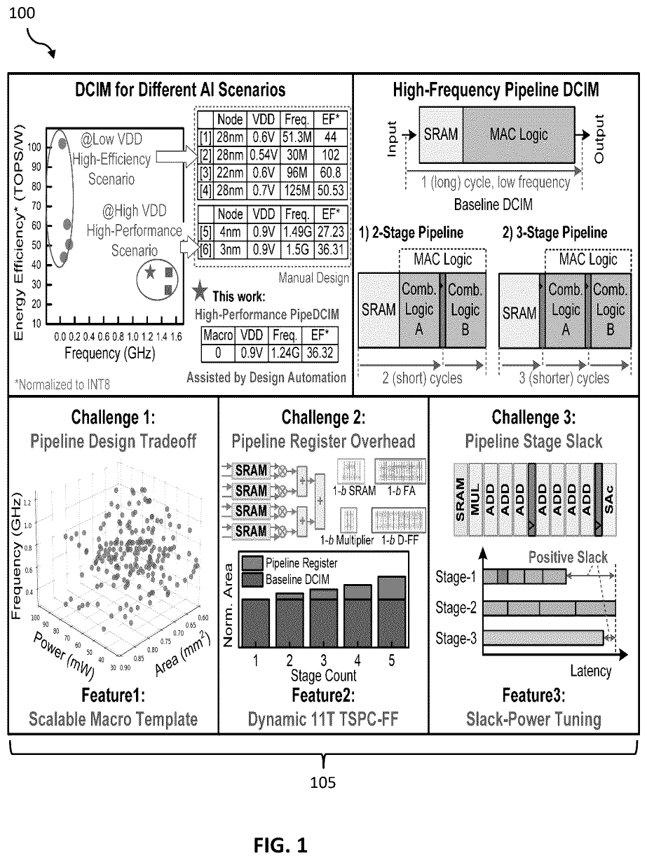

FIG. 2 is a flowchart illustrating a computer-implemented method for optimizing circuit design of a DCIM macro, in accordance with aspects of the present disclosure.

FIG. 3 depicts a schematic overview associated with the method of FIG. 2, in accordance with aspects of the present disclosure.

FIG. 4 depicts a schematic overview of an automated design tool configured based on the method of FIG. 2, and further depicts usage of the tool on a typical high-performance AI scenario, in accordance with aspects of the present disclosure.

FIG. 5 depicts a scalable DCIM macro template used by the automated design tool of FIG. 4 and the concept of design space exploration (DSE), in accordance with aspects of the present disclosure.

FIG. 6 depicts analyses of true single-phase clock flip-flop (TSPC-FF) for use in pipeline registers of a DCIM macro, based on the method of FIG. 2, in accordance with aspects of the present disclosure.

FIG. 7 depicts analyses of slack-power tuning on non-critical stages of a DCIM macro, based on the method of FIG. 2, in accordance with aspects of the present disclosure.

FIG. 8 depicts a die micrograph of a test chip that includes example DCIM macros designed using the automated design tool of FIG. 4, in accordance with aspects of the present disclosure.

FIG. 9a depicts corresponding pipeline architectures and associated circuitry characteristics of the DCIM macros arranged in the test chip of FIG. 8, in accordance with aspects of the present disclosure.

FIG. 9b is a table of measurement results comparing conventional DCIM macros with a DCIM macro arranged in the test chip of FIG. 8, in accordance with aspects of the present disclosure.

FIG. 10 depicts schematics and photographs of a test platform for evaluating the test chip of FIG. 8, in accordance with aspects of the present disclosure.

FIG. 11 depicts Shmoo plots of measurement results pertaining to frequency vs. voltage for the DCIM macros arranged in the test chip of FIG. 8, in accordance with aspects of the present disclosure.

FIG. 12 shows measurement results pertaining to pipeline stage latency and power breakdown for the DCIM macros arranged in the test chip of FIG. 8, in accordance with aspects of the present disclosure.

FIG. 13 is a block diagram of devices for optimizing circuit design of a DCIM macro, in accordance with aspects of the present disclosure.

FIG. 14 is another block diagram of devices for optimizing circuit design of a DCIM macro, in accordance with aspects of the present disclosure.

FIG. 15 is a block diagram of a compute manager for optimizing circuit design of a DCIM macro, in accordance with aspects of the present disclosure.

FIG. 16 is a schematic diagram of an exemplary computing device for performing the method of FIG. 2, in accordance with aspects of the present disclosure.

FIG. 17 is a schematic diagram of an exemplary computing device for performing the method of FIG. 2, in accordance with aspects of the present disclosure.

### DETAILED DESCRIPTION

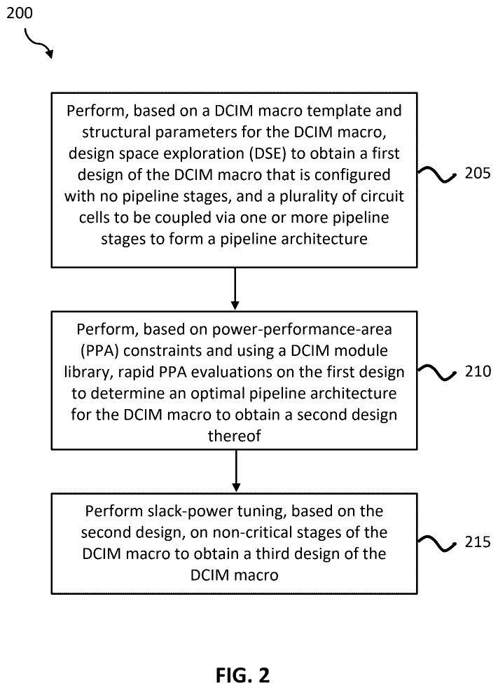

Aspects of the present disclosure set out a method and corresponding devices for optimizing circuit design of a digital compute-in-memory (DCIM) macro for improved power-performance-area (PPA) efficiency. In particular, the proposed method 200 (i.e. refer to FIG. 2) may realize a scalable pipeline DCIM macro architecture, which is herein named as “PipeDCIM” (hereafter), and said method 200 may be implemented as an end-to-end automated design tool (named as “PipeDCIM design tool” hereafter), in part, for agile development and PPA optimizations of circuitry design of DCIM macros. The method 200 may otherwise also be considered as a pipeline optimization method for DCIM macros.

According to the present disclosure, the proposed method 200 may enable the following (but is not limited to):
1) Provision of a scalable DCIM macro template to enable exploration and design of pipeline stages relating to assignation of a number and placement of the pipeline stages in DCIM macros, in accordance with PipeDCIM. Based on the scalable template, the PipeDCIM design tool permits rapid design space exploration (DSE) and further enables automated circuit generation for specified scenarios desired by chip designers.
2) PipeDCIM implements pipeline registers using true single-phase clock flip-flops (TSPC-FFs), which are considered 11T dynamic structures that have fewer transistors to reduce area overhead on (chip) die. Since PipeDCIM may frequently update the pipeline registers, the data retention issue due to dynamic circuit leakage is mitigated under the target high-performance scenarios.
3) PipeDCIM realizes slack-power tuning on non-critical stages of a DCIM macro by selectively replacing normal cells with slower lower-power cells, thus enabling power saving but without suffering performance loss by the DCIM macro.

The following description provides examples of methods and corresponding devices for optimizing circuit design of a DCIM macro, but they are not limiting on the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration”. Any aspect described herein as “exemplary” is not necessarily to be construed as preferred or advantageous over other aspects.

Aspects according to the present disclosure will be described, by way of example only, with reference to the drawings. Like reference numerals and characters in the drawings refer to like elements or equivalents.

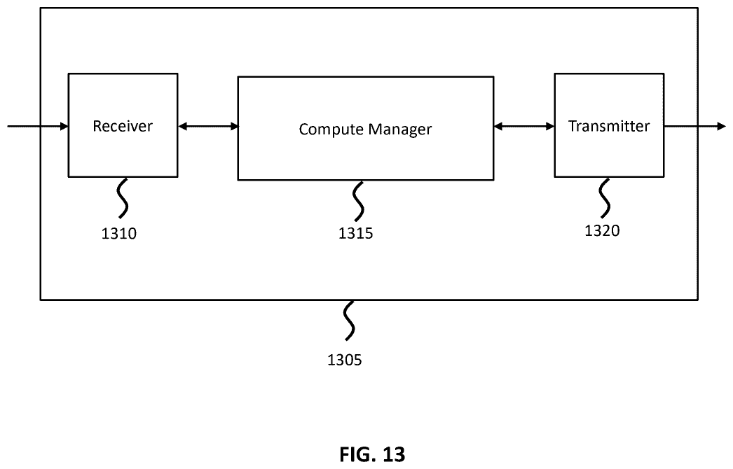

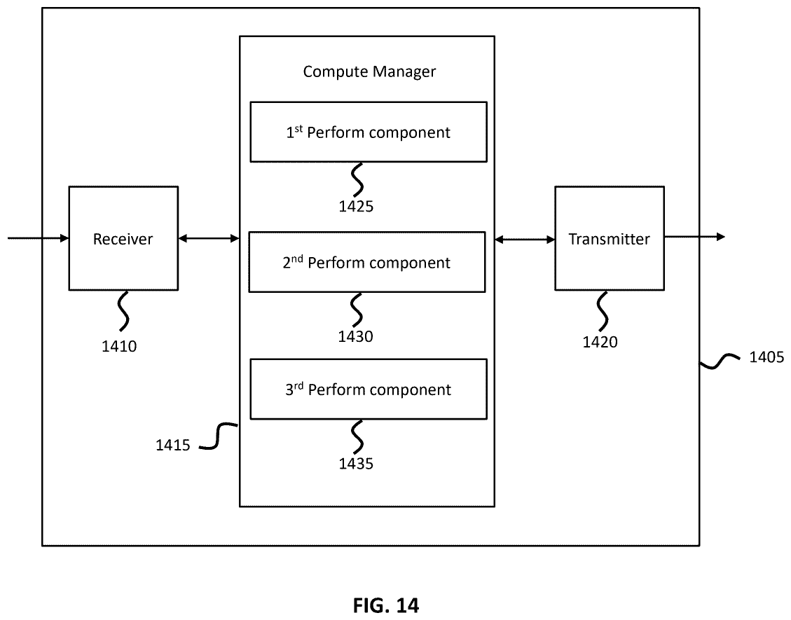

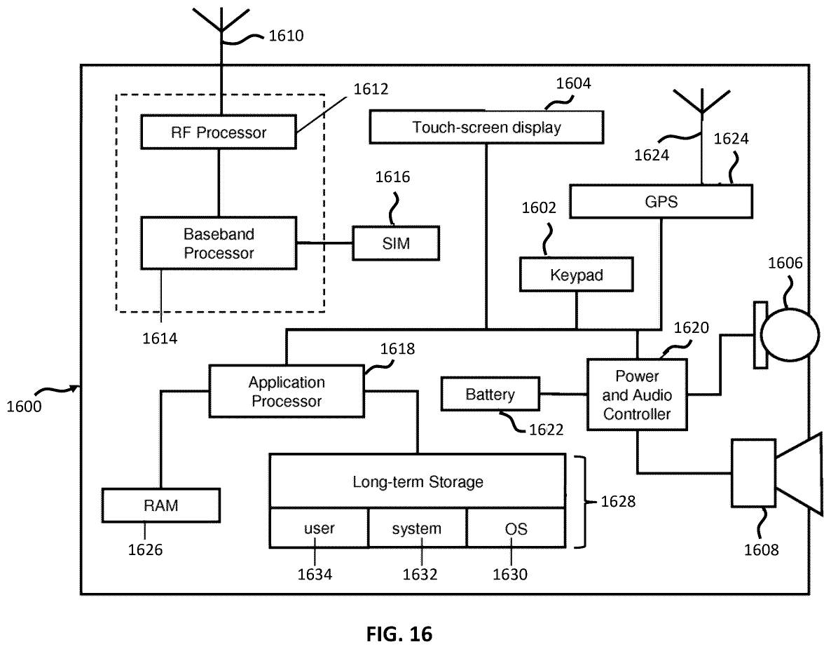

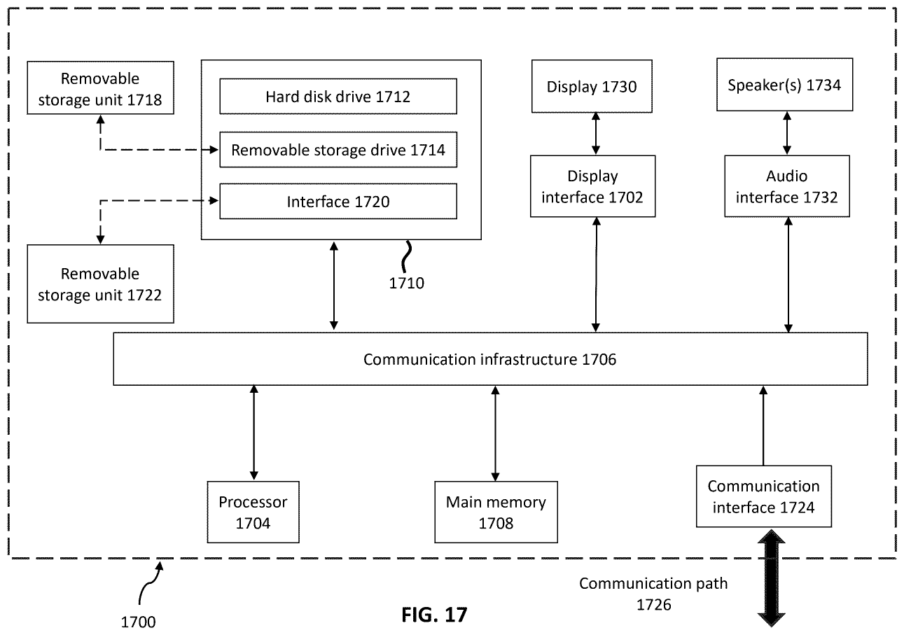

FIG. 2 is a flowchart illustrating a computer-implemented method 200 for optimizing circuit design of a DCIM macro, in accordance with aspects of the present disclosure. The operations of method 200 may be implemented by a computing device 1600, 1700 (or its components), as depicted in FIGS. 16-17. For example, the operations of method 200 may be performed by a compute manager 1315, 1415 as described with reference to FIGS. 13-14, which may be installed and executed on the computing device 1600, 1700 (or its components). In some examples, the computing device 1600, 1700 (or its components) may execute a set of instructions to control the functional elements of the computing device 1600, 1700 to perform the functions described below. Additionally or alternatively, the computing device 1600, 1700 may perform aspects of the functions described below using special-purpose hardware.

At step 205, the method 200 may comprise: performing, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture. The plurality of circuit cells may include a combination of a static random-access memory (SRAM), a bitwise-multiplier (MUL), an adder tree (AddT), and a shift-accumulator (SAc). It is to be appreciated that the structural parameters may be provided by a designer of the DCIM macro. The structural parameters for the DCIM macro are viewed as top level structure parameters for the DCIM macro, and they may include the following: input height (H), weight column (C), minimum data precision (P), and memory compute ratio (R). Also, it may be considered that the first design of the DCIM macro may be a baseline design.

At step 210, the method 200 may comprise: performing, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture. According to the method 200, pipeline registers in the optimal pipeline architecture are to be implemented based on true single-phase clock (TSPC) flip-flops (TSPC-FFs), which are configured as 11T dynamic circuit cells. It is to be appreciated that the PPA constraints may be defined by a designer of the DCIM macro.

Additionally or alternatively, it is highlighted that performing rapid PPA evaluations on the first design to determine the optimal pipeline architecture may include a number and placement of pipeline stages to be assigned between the plurality of circuit cells. The term “placement” in this context means at where between the plurality of circuit cells are the pipeline stages to be positioned.

At step 215, the method 200 may comprise: performing slack-power tuning, based on the second design, on non-critical stages of the DCIM macro defined by the optimal pipeline architecture to obtain a third design of the DCIM macro. Performing slack-power tuning includes evaluating all combinations of lower power modules for use in the non-critical stages, based on latency and power consumption criteria (i.e. a latency criterion and a power consumption criterion), to permit identification of one combination that satisfy said latency and power consumption criteria for selection as the third design. The latency criterion defines that a total latency configured for a combination is to be the largest possible, and which is less than or equal to the latency of a critical path in the determined optimal pipeline architecture. Then, the power consumption criterion defines that energy consumption by a combination is to be the lowest possible.

In some examples, the method 200 may optionally further comprise: generating, based on the third design of the DCIM macro, a hierarchical schematic design for said DCIM macro that may facilitate fabrication thereof.

In some examples, based on the third design, the DCIM macro may be configured to operate at a maximum frequency range of between 1.03 GHz to 1.40 GHz. Further, additionally or alternatively, based on the third design, the DCIM macro may be fabricated by 28 nm CMOS node (e.g. from TSMC).

In some implementations, the operations of the method 200 may be programmed into, and stored as corresponding computer-readable code that is executable by the computing device 1600, 1700 (or its components). Additionally or alternatively, the method 200 may further comprise: configuring, based on a process design kit (PDK), a DCIM cell library that includes template designs of SRAMs, full adders, and TSPC-FFs, in which the PDK may be provided by a semiconductor foundry, and may include template designs of standard circuit cells (e.g. AND gate, NOR gate, AOI gate, NAND gate, D-type flip-flop (DFF), MUX, and the like).

In some aspects, the DCIM module library may be configured based on the PDK and the DCIM cell library.

In some aspects, the template designs of the SRAMs may include a normal version and a low-power version of said SRAMs, in which relative to the normal version, the low-power version is characterized by a higher threshold voltage (Vt) and a cell structure that is configured with less energy consumption and a longer critical latency.

In further aspects, the template designs of the full adders may include a normal version and a low-power version of said full adders, in which relative to the normal version, the low-power version is characterized by a higher threshold voltage (Vt) and a cell structure that is configured with less energy consumption and a longer critical latency.

In accordance with aspects of the present disclosure, there is disclosed a computing device (e.g. the computing device 1600, 1700, as depicted in FIGS. 16-17) for optimizing circuit design of a digital compute-in-memory (DCIM) macro, comprising: one or more memories having executable code; and one or more processors coupled to the one or more memories, and configured to execute the code to cause the device to:
1) perform, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (SAc);
2) perform, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and
3) perform slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

Further details regarding the above various aspects of the disclosed method 200 are set out by the description below.

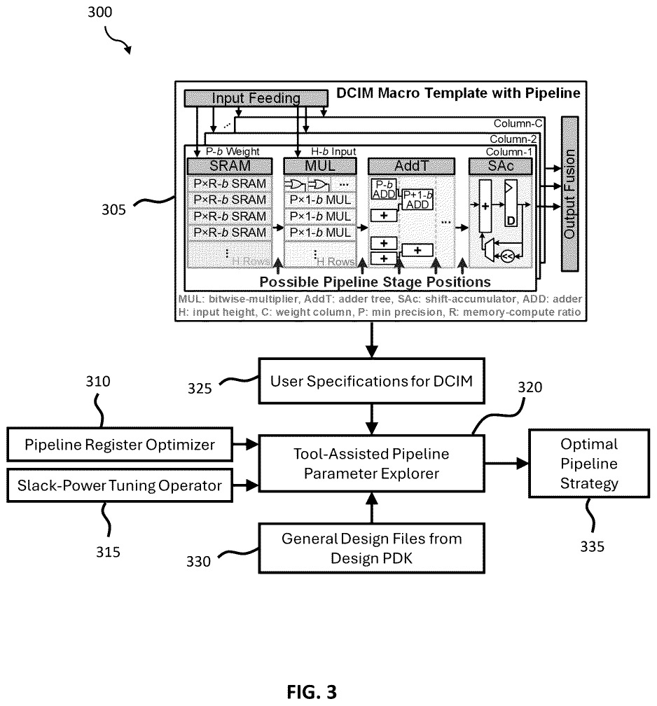

In accordance with aspects of the present disclosure, FIG. 3 depicts a schematic overview 300 associated with the proposed method 200 of FIG. 2. More specifically, based on PipeDCIM, a scalable DCIM macro template 305 for a scalable DCIM macro structure with a pipeline design space is proposed, as shown in FIG. 3. The macro template 305 is devised to be logically divided into the following segments (or portions): a SRAM segment, a MUL segment, an AddT segment, and a SAc segment, which are arranged with peripherals for input feeding and output fusion.

It is to be appreciated that pipeline stages may be assigned and inserted between the various different segments, and also at inner levels within the AddT segment, as desired according to design requirements.

According to design specifications defined by a designer (i.e. being a user of the PipeDCIM design tool), the proposed method 200 includes three aspects that may be implemented as corresponding features in the PipeDCIM design tool: a pipeline register optimizer 310 (i.e. referred to as Feature 1), a slack-power tuning operator 315 (i.e. referred to as Feature 2), and a tool-assisted pipeline parameter explorer 320 (i.e. referred to as Feature 3). The tool-assisted pipeline parameter explorer 320 is configured to receive inputs in the form of user specifications 325 for the intended DCIM macro, and general design files from at least one PDK 330 (which may be provided by a foundry). Accordingly, the PipeDCIM design tool may enable determination of an optimized pipeline strategy 335 (as output) vis-à-vis a circuity design for a DCIM macro.

Feature 1: The pipeline register optimizer 310 implements a circuit optimization step designed to utilize less transistors for register circuit designs in order to reduce area overheads associated with arranging pipeline stages in DCIM macros. For instance, a dynamic 11T TSPC-FF, rather than a standard DFF, may advantageously be used in pipeline registers. Since DCIM macros frequently update pipeline registers, the data retention issue caused by dynamic circuit leakage may be avoided, with regards to using TSPC-FFs, under the targeted high-performance scenarios.

Feature 2: Slack-power tuning operator 315 implements a further circuit optimization step designed to provide functional cell-level design, based on using slower (in terms of latency speed) and lower-power implementations. Since the achieved highest frequency in a DCIM macro is determined by the associated latency of the critical path, configuring by increasing the total latency for non-critical stages (of the DCIM macro) to be (sufficiently) near to, or otherwise as close as possible to the critical latency with decreasing power consumption may be realized to enhance the overall energy efficiency of the DCIM macro, without suffering from frequency degradation (to impact performance).

In this context, “near to (the critical latency)” means the total latency is the closest possible to, but does not exceed, the critical latency. It is to be appreciated that providing an exact numerical value to technically qualify “near to” may not be possible in context of the present disclosure, because the value likely varies on a case-by-case basis, since the definition of “near to” for the total latency vis-à-vis the critical latency is dependent at least on a specific design for the DCIM macro and the available design options in each case. Rather, the general guiding principle is to minimize the timing slack: out of all possible combinations for implementing the non-critical stages of the DCIM macro under the slack-power tuning process, the one combination that affords the largest latency and which is still less than or equal to the critical latency is selected as the eventual combination.

Feature 3: The disclosed method 200 may be implemented under the PipeDCIM design tool to enable ease of exploration on assignation of a number and placement of pipeline stages to provide an agile, and scalable way to optimize circuitry design of DCIM macros. Based on the scalable DCIM macro template, designs of pipeline stages with various configurations may then be generated using the PipeDCIM design tool to allow quick identification of an optimal pipeline design for a DCIM macro, in relation to a desired use scenario.

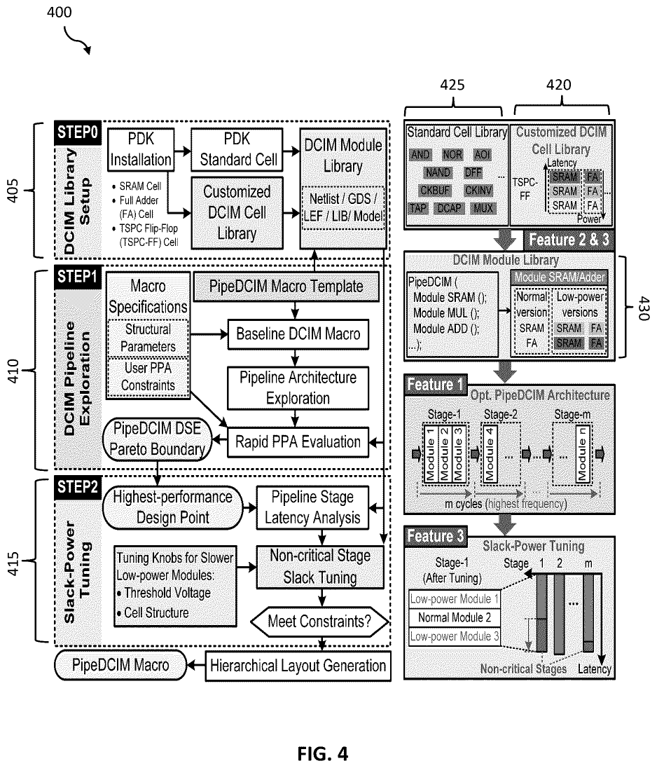

FIG. 4 depicts a schematic overview 400 of the PipeDCIM design tool configured based on the proposed method 200 of FIG. 2, and it further depicts usage of said tool on a typical high-performance AI scenario (wherein maximum performance is set as a 1^{st} objective, and minimum power is set as a 2^{nd} objective, and a die area of the DCIM macro is to be ≤A, where “A” is a parameter defined by a user), in accordance with aspects of the present disclosure.

Particularly, the PipeDCIM design tool is designed to integrate those features being: the pipeline register optimizer 310 (i.e. Feature 1), the slack-power tuning operator 315 (i.e. Feature 2), and the tool-assisted pipeline parameter explorer 320 (i.e. Feature 3), as afore discussed with reference to FIG. 3. It is to be appreciated that the PipeDCIM design tool may be executed with reference to a sequence that includes three broad steps: (1). DCIM library setup (i.e., labelled as “STEP0” 405 in FIG. 4), (2). DCIM pipeline exploration (i.e., labelled as “STEP1” 410 in FIG. 4), and (3). Slack-power tuning (i.e., labelled as “STEP2” 415 in FIG. 4).

At STEP0 405, a customized DCIM cell library 420 that includes template designs of SRAM cells, full adder (FA) cells, and TSPC-FF cells is developed, based on a PDK provided by a (semiconductor) foundry. The PDK provides a standard cell library 425 of basic cells. It is to be appreciated that the template designs of the SRAM cells and the FA cells come with a normal version and a low-power version, the latter which is characterized by threshold voltage (Vt) and a cell structure with less energy consumption but longer critical latency. That is to say, the low-power version is configured to use higher threshold voltage transistors in the cell circuit, or other cell structure configured with the same function, and with less leakage power (i.e. thus leading to lower power consumption), but with longer critical latency. Based on the standard cell library 425 and the customized DCIM cell library 420, a DCIM module library 430 with design files of all types of cell modules (that may be used for designing DCIM macros), based upon PipeDCIM, is developed. Hence, STEP0 405 may be viewed as initializing the DCIM module library 430. It is to be appreciated that STEP0 405 in some examples may be optional, since the libraries may alternatively be provided as self-contained software modules by third party software vendors (and thus, initialization of the DCIM module library 430 is not necessary).

At STEP1 410, after the library initialization at STEP0 405, the PipeDCIM design tool is configured to perform DSE, based on the scalable DCIM macro template 305 (as discussed under at FIG. 3) and required specifications provided by a user for a DCIM macro. The specifications include structural parameters, and PPA constraints for the DCIM macro. The structural parameters may set out the design of a baseline DCIM macro (i.e. 1^{st} design) that is arranged with normal cells, and no pipelining. As explained, the structural parameters may include the following: input height (H), weight column (C), minimum data precision (P), and memory compute ratio (R). The scalable DCIM macro template 305 may be based upon the DCIM module library 430. It is to be appreciated this process under STEP1 410 may correspond to step 205 of the disclosed method 200.

Then, pipeline architecture exploration is conducted (via rapid PPA evaluations), based on the 1^{st} design to form a design space to explore and determine different the stage counts for the pipeline stages, and possible placement of those pipeline stages. It is to be appreciated this process may correspond to step 210 of the disclosed method 200. In view of the PPA constraints and in conjunction with using the DCIM cell library, a Pareto boundary is then formed by the rapid PPA evaluations on the 1^{st} design to arrive at a 2^{nd} design with the optimal pipeline architecture. A maxima of a point set on the Pareto boundary corresponds to indication of the optimal pipeline architecture that is to be reached under the 1^{st} objective of maximum performance.

At STEP2 415, the PipeDCIM design tool is configured to further perform slack-power tuning on non-critical stages of the DCIM macro, based on the 2^{nd} design, to arrive at a 3^{rd} design of the intended DCIM macro. It is to be appreciated this process may correspond to step 215 of the disclosed method 200. By exploring different lower-power module versions, the (overall) total latency of the non-critical stages (in the design) is increased to the near-critical level, thus maximizing power reduction to be reached under the 2^{nd} objective of minimum power.

It is to be appreciated that in this context, “exploring different lower-power module versions” means all possible combinations of the low-power versions are to be systematically explored and evaluated by the PipeDCIM design tool at STEP2 415. That is, for each combination which generates a resulting design of the DCIM macro, the latency and power consumption of said design are evaluated. The process for selecting a particular combination (from amongst all the combinations) to adopt as the final design for the DCIM macro is set out as:
(1). Latency Constraint: Among all the combinations, the combinations with overall (total) latency closest to, but do not exceed, the critical latency constraint for the design of the DCIM macro are first identified. It may well be that there is only one combination identified in some instances.
(2). Power Optimization: If multiple combinations are identified to meet the criterion under the latency constraint, one specific combination (from those multiple combinations) with the lowest overall power consumption is selected as the 3^{rd} design for the intended DCIM macro. Therefore, the selected combination is the one that satisfies the latency requirement with the minimal power usage for the intended DCIM macro. So, guided by the latency and power criteria, slack-power tuning is an exhaustive search and evaluation process performed by the PipeDCIM design tool.

Consequently, the PipeDCIM design tool outputs the 3^{rd} design (as the final design) of the DCIM macro that has the lowest-power, with no (or minimal) performance loss, and may also generate a hierarchical schematic design for said DCIM macro to facilitate subsequent fabrication thereof. The PipeDCIM design tool is also designed to permit installation of future plugin extensions for advanced technology, macro architecture, and circuit design techniques.

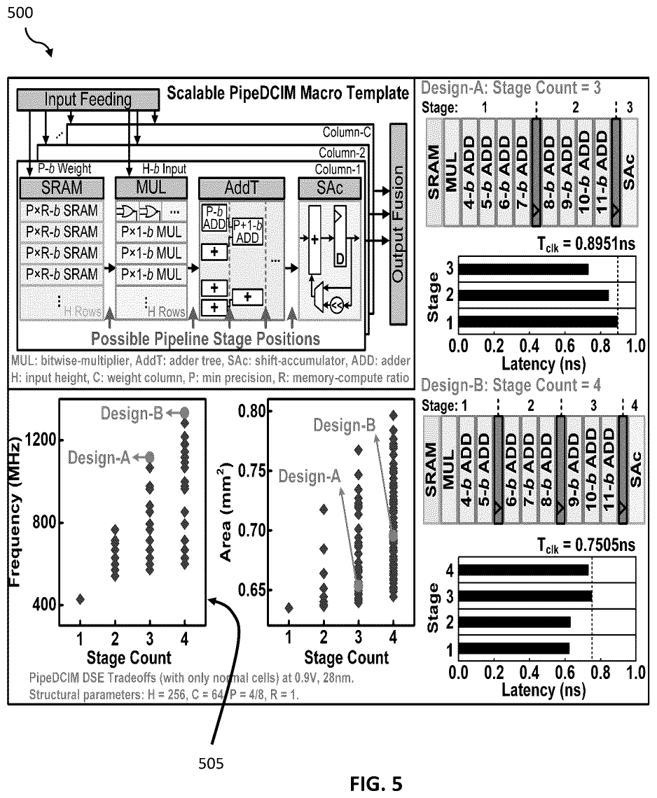

FIG. 5 depicts a scalable DCIM macro template 500 used by the PipeDCIM design tool of FIG. 4 and the concept of design space exploration (DSE), in accordance with aspects of the present disclosure. It is to be appreciated that the DCIM macro template 500 herein is same as the scalable DCIM macro template 305 of FIG. 3. Moreover, it is to be appreciated that each segment (i.e. the SRAM segment, the MUL segment, the AddT segment, and the SAc segment) in the DCIM macro template 500 is constructed by DCIM modules pre-implemented in the DCIM module library 430 (i.e. P×R−b SRAM, P×1−b MUL, P−b ADD), wherein the SRAM and ADD modules are tunable by adjusting the SRAM and FA cell versions.

Based on DSE, FIG. 5 also shows that the pipeline DSE tradeoffs with only normal cells at 0.9 V, TSMC 28 nm CMOS node, under the parameters of H=256, C=64, P=4/8, and R=1. To reiterate, H represents height, C represents weight column, P represents minimum data precision, and R represents memory compute ratio. The baseline DCIM macro designed without pipelining has a die size of 0.6347mm² , and runs at 427.48 MHz. In a frequency plot 505 depicted in FIG. 5, Design-A is assessed to be the highest-performance point, and a DCIM macro (under Design-A) is arranged with 3 pipeline stages, which inserts pipeline registers after the 7-b ADD level and at the end of AddT. The operating frequency of the DCIM macro under Design-A is configured to be 1.12 GHz, which is 2.62 times higher than the baseline design, incurring only 2.85% of area overhead costs.

Again in the same frequency plot 505 depicted in FIG. 5, Design-B is the highest-performance point, and a DCIM macro (under Design-B) is arranged with 4 pipeline stages, in which the pipeline stage positions in AddT are adjusted and a new pipeline stage is added. The operating frequency of the DCIM macro under Design-B is configured to be 1.33 GHz, which is 3.11 times higher than the baseline design, incurring only 9.53 % of area overhead costs.

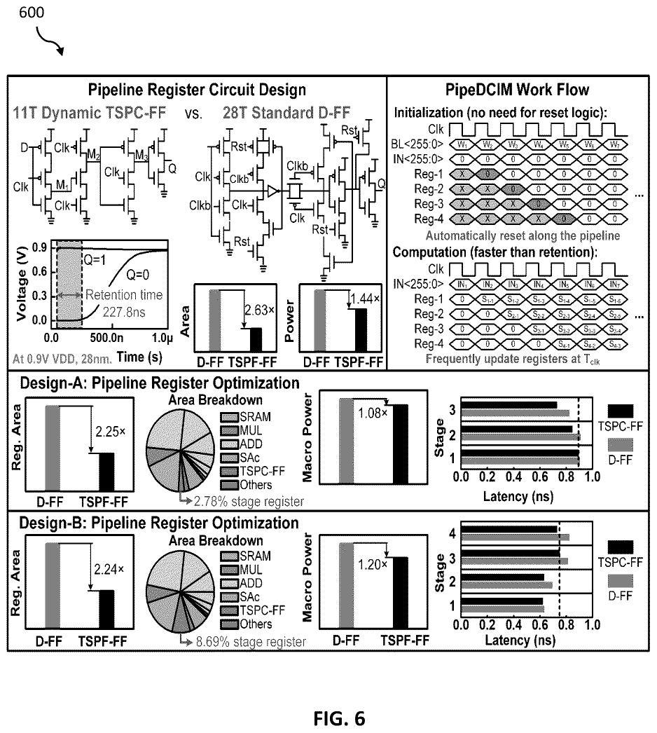

FIG. 6 depicts analyses 600 of TSPC-FF to be used in pipeline registers of a DCIM macro, based on the proposed method 200 of FIG. 2, in accordance with aspects of the present disclosure. Compared with the standard DFF, TSPC-FF is an 11T dynamic circuit implemented without reset logic. The TSPC-FF is configured with 11 transistors, versus 17 transistors in the standard DFF. This reduced usage of transistors beneficially saves die area by 2.63 times, and further reduces power consumption by 1.44 times. As shown in FIG. 6, during initialization, keeping inputs may automatically reset all registers along the pipeline stages, and so specific reset logic for pipeline registers becomes unnecessary. Moreover, while the dynamic structure of TSPC-FF may cause data retention issue, it is inherently addressed and mitigated by the high-frequency pipelining realized under PipeDCIM.

In measurements, the retention time of TSPC-FF is measured to be 227.8 ns, at 0.9V, TSMC 28 nm CMOS node, which is considered to be within the safe margins for maintaining data integrity, because it is significantly longer than the typical clock period (e.g. smaller than 1 ns) of high-frequency pipelining under PipeDCIM. Accordingly, by using TSPC-FF in pipeline registers, a pipeline register area of 2.25 times and 2.24 times may be saved under Design-A and Design-B, which decreases corresponding ratio to 2.78 % and 8.69 % respectively of the entire DCIM macro. It is to be appreciated that the term “ratio” in the context of the preceding sentence refers to the ratio of the area occupied by the TSPC-FF to the total area of the entire DCIM macro. Besides saving die area for implementing the pipeline registers, the operating power of the respective DCIM macros under Design-A and Design-B may be reduced by 7.29 % and 16.32 % respectively, with 0.96 % to 11.34 % lower latency per pipeline stage.

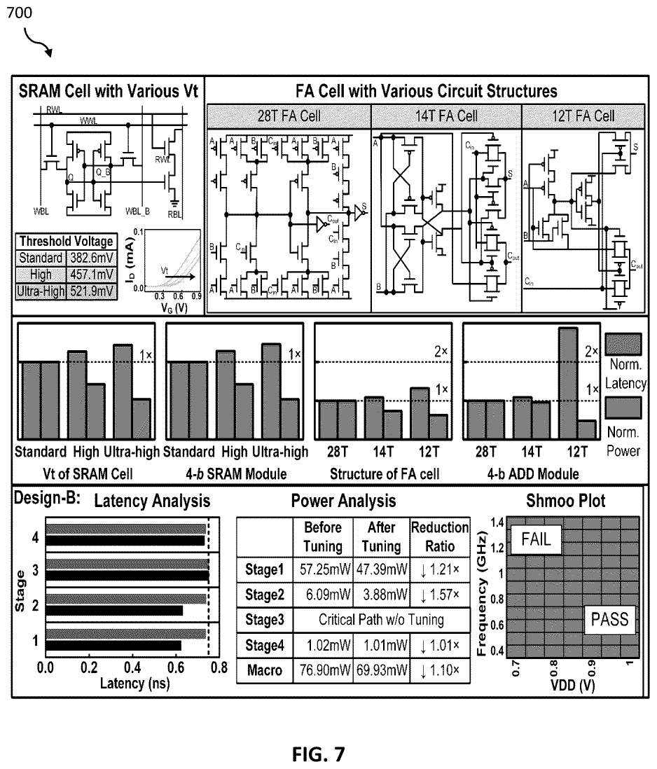

FIG. 7 depicts analyses 700 of slack-power tuning on non-critical stages of a DCIM macro, based on the method 200 of FIG. 2, in accordance with aspects of the present disclosure. In DCIM macros, SRAM and AddT cells usually occupy over 70 % power consumption [ref. 8], and so according to the method 200, it is proposed to perform slack-power tuning on the SRAM and FA cells (i.e. refer also to STEP2 415 at FIG. 4), in which: a 1-b SRAM cell is implemented in a normal version (e.g. at standard Vₜ of 382.6 mV) and two low-power versions (e.g. at high Vₜ of 457.1 mV; and at ultra-high Vₜ of 529.1 mV). A 1-b FA cell is then implemented in 28T, 14T, and 12T versions to construct the ADD module. For a 4-b SRAM module, high and ultra-high Vₜ respectively achieve 28.63 % and 47.83 % in power saving, with 1.14 times and 1.23 times longer latency.

For a 4-b ADD module, the 14T and 12T versions respectively achieve 3.88 % and 51.11 % in power saving, with 1.10 times and 2.87 times longer latency. Referring to Design-B discussed under FIG. 5, “Stage3” (of the pipeline stages) is considered the critical path. “Stage4” (of the pipeline stages) has a fairly short slack, so tuning Stage4 may only bring about 0.90 % reduction in operating power. “Stage 1” and “Stage 2” (of the pipeline stages) are able to obtain 1.18 times and 1.17 times longer latency without exceeding the latency of Stage 3, and are able to achieve 17.22 % and 36.29 % reduction in operating power. Under the same frequency, the entire DCIM macro achieves a 9.06 % reduction in operating power.

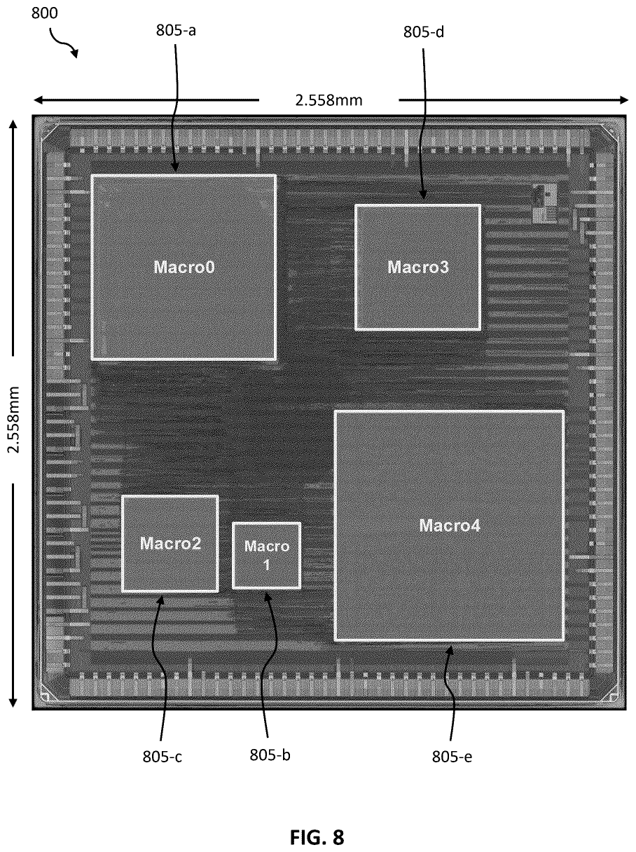

In an example, Design-B is tapped out to validate the disclosed techniques under the method 200, in which five example DCIM macros are designed using the PipeDCIM design tool and arranged in a die micrograph of a test chip 800 for testing and validating purposes—see FIG. 8. The test chip 800 dimensionally measures about 2.558 mm (L) by 2.558 (W) mm

in size. In FIG. 8, on the test chip 800, the five DCIM macros are labelled as “Macro0” 805-a, “Macro1” 805-b, “Macro2” 805-c, “Macro3” 805-d, and “Macro4” 805-e to facilitate ease of discussions herein.

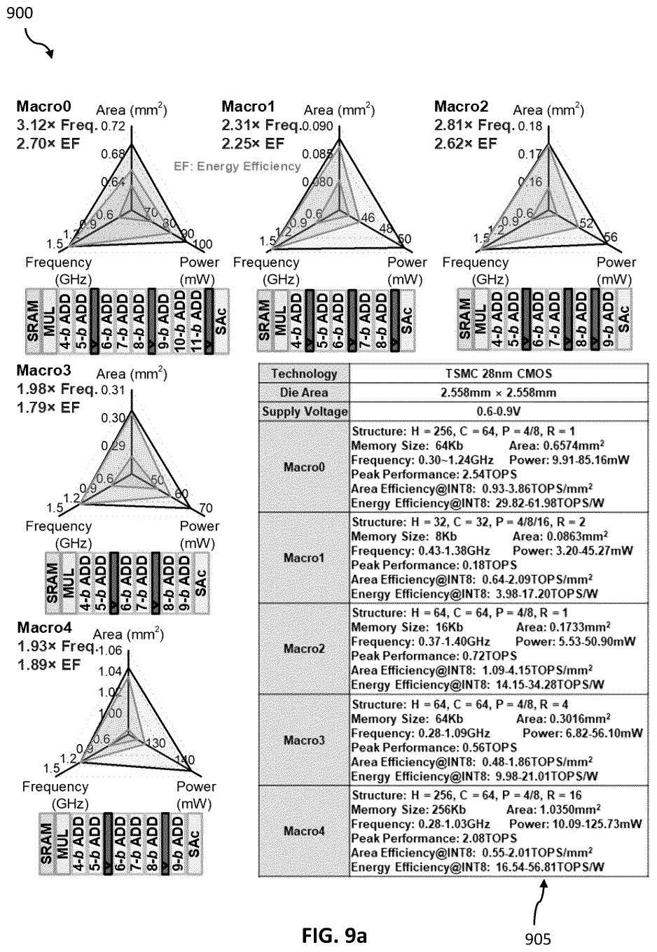

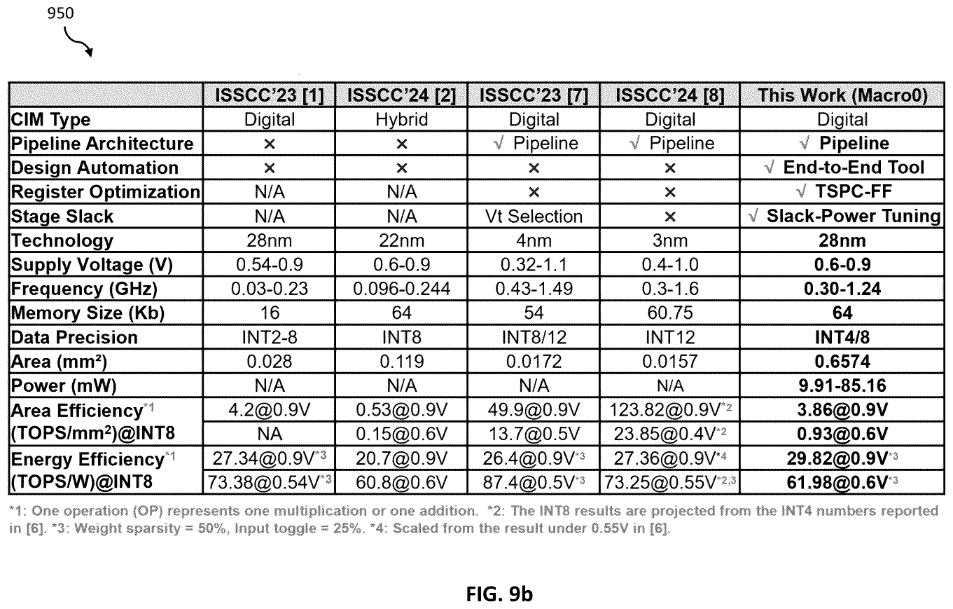

FIG. 9a depicts corresponding pipeline architectures 900, together with a summary table 905 detailing the associated circuitry characteristics, of the (five) DCIM macros 805-a, 805-b, 805-c, 805-d, 805-e arranged in the test chip 800 of FIG. 8, in accordance with aspects of the present disclosure.

Referring again to FIG. 8, in an example, the five DCIM macros 805-a, 805-b, 805-c, 805-d, 805-e are fabricated using TSMC 28 nm CMOS node. It is to be appreciated that, in this instance, the said DCIM macros 805-a, 805-b, 805-c, 805-d, 805-e are configured to be between 8~256 Kb in capacity, 0.0863~1.0350 mm² in die size, 1.03~1.40 GHz of maximum frequency, and operate at 45.27~125.73 mW at 0.9 V, which may function as CIM cores for diverse high-performance AI applications. Comparing the functional-equivalent baselines without pipelining versus the ones designed by the proposed method 200, the proposed DCIM macros 805-a, 805-b, 805-c, 805-d, 805-e are able to achieve 1.93~3.12 times higher frequency and 1.79~2.70 times energy efficiency, with only 1.02~1.15 times and 1.04~1.10 times increase in power and area.

In accordance with aspects of the present disclosure, the DCIM macro labelled as “Macro0” 805-a in the test chip 800 of FIG. 8 is also compared with conventional CIM macros, as depicted in FIG. 9b. FIG. 9b shows a table 905 of measurement results comparing “Macro0”805-a against conventional DCIM macros. In an example, “Macro 0 ” 805-a is configured to function at 0.6 to 0.9 V, 0.30~1.24 GHz. Beneficially, due to use of DSE afforded under the PipeDCIM design tool, the optimal pipeline architecture may be determined under given constraints. The proposed pipeline architecture under PipeDCIM achieves 5.39 times and 5.08 times higher frequency than the two non-pipelining CIM macros in 28nm [ref. 1-2] at 0.9 V. The operating frequency evaluated for “Macro0” 805-a is even comparable to the two TSMC DCIM macros configured with pipelining (running at 1.49 GHz, and 1.60 GHz respectively) in more advanced 4 nm and 3 nm nodes [ref. 7-8].

Due to the speedup provided by way of Feature 1 (i.e. refer to the discussions at FIG. 3) and power saving by way of Features 2-3 (i.e. refer also to the discussions at FIG. 3), PipeDCIM is able to achieve a peak INT8 energy efficiency of 29.82TOPS/W at 0.9 V, which is 1.09 times and 1.44 times higher respectively than the prior art under [ref. 1] and [ref. 2] that focus on energy efficiency optimization. The silicon-validated results indicate that the proposed scalable PipeDCIM architecture, assisted by the PipeDCIM design tool, provides a promising solution for agile DCIM development. It is to be appreciated that the PipeDCIM design tool allows users to easily develop customized DCIM macros by simply providing structural parameters and PPA constraints. The proposed IC design methodology may beneficially assist in enabling a sustainable ecosystem for DCIM macros and processors, especially in the area of rapidly evolving AI applications.

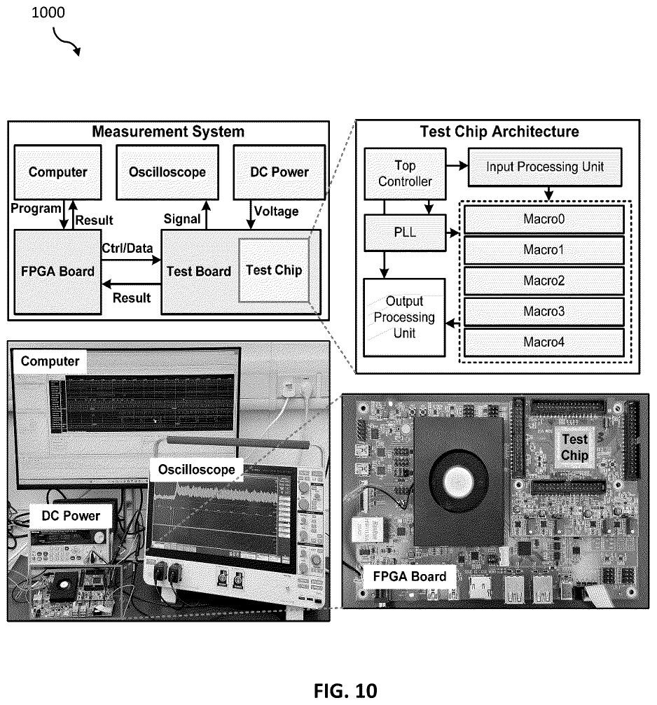

FIG. 10 depicts schematics and photographs of a test platform 1000 arranged for evaluating the test chip 800 of FIG. 8, in which an FPGA transmits control signals and data to the test chip 800, and the DC power supplies 0.7 to 1.0 V core voltage for the test chip 800, and computing results from the test chip 800 collected by the FPGA are forwarded to a computer for analyses, in accordance with aspects of the present disclosure.

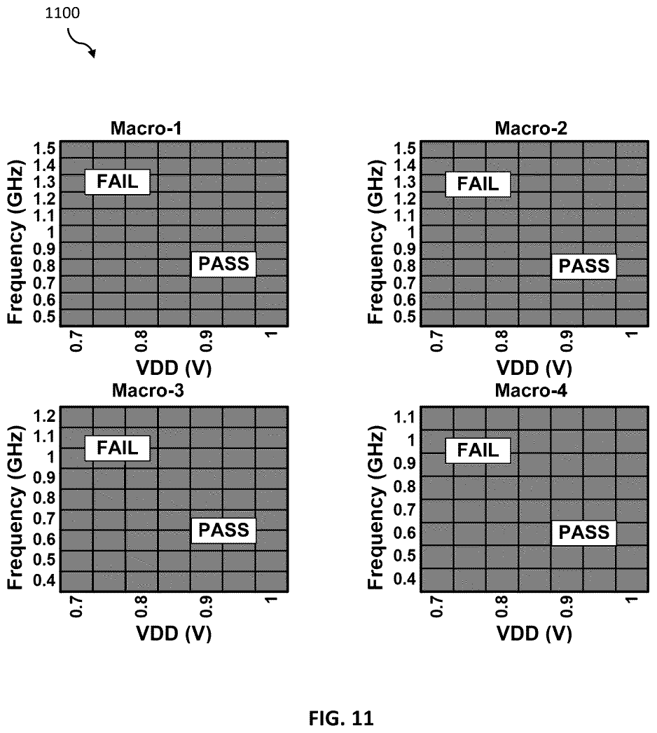

FIG. 11 depicts Shmoo plots 1100 of measurement results pertaining to frequency versus voltage for the DCIM macros 805-a, 805-b, 805-c, 805-d, 805-e configured in the test chip 800 of FIG. 8, in accordance with aspects of the present disclosure. It is to be appreciated that the measured frequency at 0.9 V reaches 1.24 GHz (being about 93.23 % close to simulation), which validates the accuracy of the design realized under the PipeDCIM design tool.

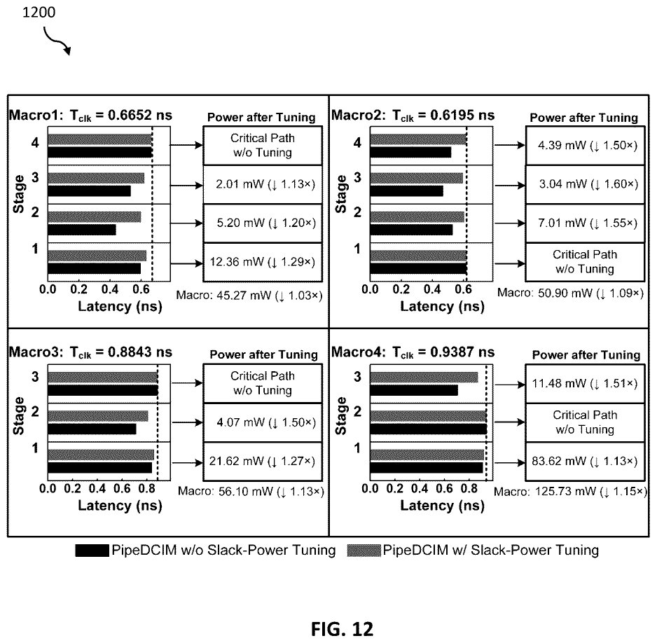

FIG. 12 shows measurement results 1200 pertaining to pipeline stage latency and power breakdown for four of the five DCIM macros 805-b, 805-c, 805-d, 805-e configured in the test chip 800 of FIG. 8, in accordance with aspects of the present disclosure.

FIG. 13 is a block diagram of a device 1305 for optimizing circuit design of a DCIM macro, in accordance with aspects of the present disclosure. The device 1305 may be an example of aspects of a computing device 1600, 1700 of FIGS. 16-17, and may be configured to perform the method 200 of FIG. 2. The device 1305 may include a receiver 1310, a compute manager 1315, and a transmitter 1320. The compute manager 1315 may be implemented, at least in part, by one or both of a modem and a processor. Each of these components may be in communication with one another (e.g. via one or more buses).

The receiver 1310 may receive information such as packets, user data, or control information associated with various information channels (e.g. control channels, data channels, or the like). Information may be passed on to other components of the device 1305. The receiver 1310 may be an example of aspects of a radio receiver, or an Ethernet adaptor. In some examples, the receiver 1310 may utilize a single antenna or a set of antennas (e.g. for MIMO communications).

The compute manager 1315 may be configured to perform the following:
(1). Perform, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (Sac);
(2). Perform, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and
(3). Perform slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

The transmitter 1320 may transmit signals generated by other components of the device 1305. For example, the transmitter 1320 may be an example of aspects of a radio transmitter, or an Ethernet adaptor. In some examples, the transmitter 1320 may utilize a single antenna or a set of antennas (e.g. for MIMO communications). In some examples, the transmitter 1320 may be collocated with the receiver 1210 in a transceiver component.

FIG. 14 is a block diagram of a device 1405 for optimizing circuit design of a DCIM macro, in accordance with aspects of the present disclosure. The device 1405 may be an example of aspects of a device 1305, or a computing device 1600, 1700 of FIGS. 16-17, and may be configured to perform the method 200 of FIG. 2. The device 1405 may include a receiver 1410, a compute manager 1415, and a transmitter 1420. The compute manager 1415 may be implemented, at least in part, by one or both of a modem and a processor. Each of these components may be in communication with one another (e.g. via one or more buses).

The receiver 1410 may receive information such as packets, user data, or control information associated with various information channels (e.g. control channels, data channels, or the like). Information may be passed on to other components of the device 1405. The receiver 1410 may be an example of aspects of a radio receiver, or an Ethernet adaptor. The receiver 1410 may utilize a single antenna or a set of antennas (e.g. for MIMO communications).

The compute manager 1415 may include a first (1^{st}) perform component 1425, a second (2^{nd}) perform component 1430, and a third (3^{rd}) perform component 1435.

The 1^{st} perform component 1425 may perform, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (Sac).

The 2^{nd} perform component 1430 may perform, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs).

The 3^{rd} perform component 1435 may perform slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

In some examples, it is possible that the 1^{st} perform component 1425, the 2^{nd} perform component 1430, and the 3^{rd} perform component 1435 may be implemented as a single perform component configured to collectively perform all the functions of said three components 1425, 1430, 1435.

The transmitter 1420 may transmit signals generated by other components of the device 1405. For example, the transmitter 1420 may be an example of aspects of a radio transmitter, or an Ethernet adaptor. The transmitter 1420 may utilize a single antenna or a set of antennas (e.g. for MIMO communications). In some examples, the transmitter 1320 may be collocated with the receiver 1410 in a transceiver component.

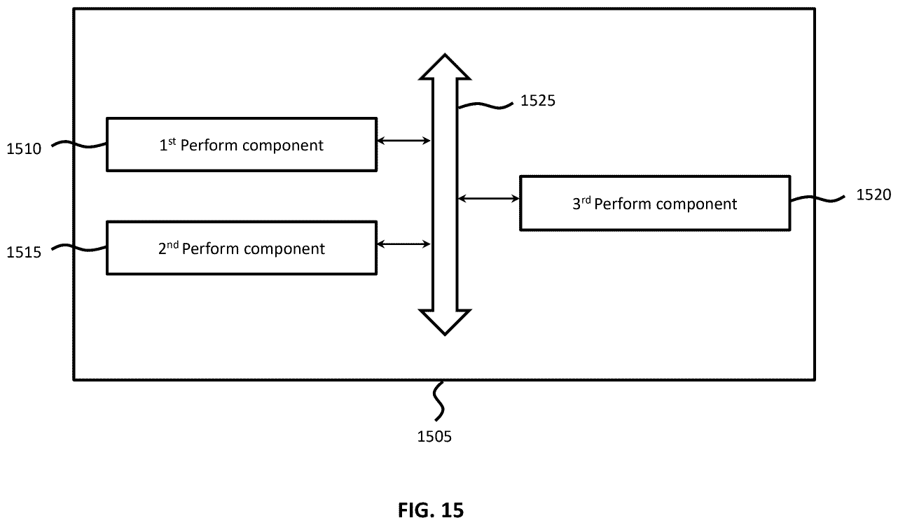

FIG. 15 is a block diagram of a communications manager 1505 for optimizing circuit design of a DCIM macro, in accordance with aspects of the present disclosure. The communications manager 1505 may be an example of aspects of a compute manager 1315 (in FIG. 13), or a compute manager 1415 (in FIG. 14) described herein. The communications manager 1505 may include a 1^{st} perform component 1510, a 2^{nd} perform component 1515, and a 3^{rd} perform component 1520. Each of these components may communicate 1525, directly or indirectly, with one another (e.g. via one or more buses).

The 1^{st} perform component 1510 may perform, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (Sac).

The 2^{nd} perform component 1515 may perform, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs).

The 3^{rd} perform component 1520 may perform slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

In some examples, it is possible that the 1^{st} perform component 1510, the 2^{nd} perform component 1515, and the 3^{rd} perform component 1520 may be implemented as a single perform component configured to collectively perform all the functions of said three components 1510, 1515, 1520.

FIG. 16 is a schematic diagram of an exemplary (first) computing device 1600 for executing and performing the method 200 of FIG. 2, in accordance with aspects of the present disclosure.

The computing device 1600 may comprise a keypad 1602, a touch-screen 1604, a microphone 1606, a speaker 1608 and an antenna 1610. The computing device 1600 may be operated by a user to perform a variety of different functions/tasks, for example, making a telephone call, sending an SMS message, browsing the Internet, sending emails, providing satellite navigation, or the like.

The computing device 1600 may comprise hardware to perform communication functions (e.g. telephony, or data communication), together with an application processor and corresponding supporting hardware to enable the computing device 1600 to establish other functions, for example, messaging, Internet browsing, email functions or the like. The communication hardware may include a radio frequency (RF) processor 1612, which provides an RF signal to the antenna 1610 for the transmission of data signals, and the receipt therefrom. A baseband processor 1614 may be provided, which provides signals to, and receives signals from the RF processor 1612. The baseband processor 1614 may also interact with a subscriber identity module (SIM) 1616, as known in the art. The communication subsystem enables the computing device 1600 to communicate via a number of different communication protocols including 3G, 4G, 5G, New Radio (NR), GSM, WiFi, BluetoothTM and/or CDMA. The communication subsystem of the computing device 1600 is beyond the scope of the present disclosure.

The keypad 1602 and the touch-screen 1604 are controlled by an application processor 1618. A power and audio controller 1620 is provided to supply power from a battery 1622 to the communication subsystem, the application processor 1618, and the other hardware. The power and audio controller 1620 may also control input from the microphone 1606, and audio output via the speaker 1608. There may also be provided a global positioning system (GPS) antenna and associated receiver element 1624, which is controlled by the application processor 1618 and is capable of receiving a GPS signal for use with a satellite navigation functionality of the computing device 1600.

Various different types of memory may be provided in the computing device 1600 to supplement operations of the application processor 1618. The computing device 1600 may include Random Access Memory (RAM) 1626 coupled to the application processor 1618 into which data and program code may be written and read from. Executable code stored in RAM 1626 may be executed by the application processor 1618 from RAM 1626. RAM 1626 represents a form of volatile memory of the computing device 1600.

The computing device 1600 may further be provided with a non-volatile (long-term) storage 1628 coupled to the application processor 1618. The storage 1628 may logically be divided into three partitions: an operating system (OS) partition 1630, a system partition 1632, and a user partition 1634. The storage 1628 may represent a non-volatile memory of the computing device 1600.

In an example, the OS partition 1630 may include firmware of the computing device 1600, which includes an operating system. Other computer programs may also be stored in the storage 1628, such as application programs (also referred to as apps), and the like. Particularly, application programs considered critical to functioning of the computing device 1600, for example, in the case of a smartphone, communications applications and the like, are typically stored in system partition 1632. The application programs stored on the system partition 1632 typically may be programmed in the computing device 1600 in its default factory setting.

Application programs subsequently added and installed on the computing device 1600 by the user may typically be stored in the user partition 1634.

The various functional components illustrated in FIG. 16 may alternatively be collocated into a single component. For example, the storage 1628 may comprise NAND flash, NOR flash, a hard disk drive or a combination of these.

FIG. 17 is a schematic diagram of an exemplary (second) computing device 1700 that may be utilized for executing and performing the method 200 of FIG. 2, in accordance with aspects of the present disclosure. The following description of the computing device 1700 is provided by way of example only and is not intended to be limiting.

As depicted in FIG. 17, the example computing device 1700 may include a processor 1704 for executing software routines/programs. While only a single processor is shown for brevity, the computing device 1700 may also be configured as a multi-processor system (i.e. includes multiple processors). The processor 1704 is coupled to a communication infrastructure 1706 for communication with other components of the computing device 1700. The communication infrastructure 1706 may include, for example, a communications bus, a crossbar network, or a network.

The computing device 1700 further includes a main memory 1708, such as a random-access memory (RAM), and a secondary memory 1710. The secondary memory 1710 may include, for example, a hard disk drive 1712 and/or a removable storage drive 1714, which may include a floppy disk drive, a magnetic tape drive, an optical disk drive, or the like. The removable storage drive 1714 reads from and/or writes to a removable storage unit 1718, as known in the art. The removable storage unit 1718 may include a floppy disk, magnetic tape, optical disk, universal serial bus (USB) flash disk, or the like, which is read by and/or written to by removable storage drive 1714. As may be appreciated by skilled persons in the art, the removable storage unit 1718 may further include a computer readable storage medium having stored therein computer executable program code instructions and/or data.

In other aspects, the secondary memory 1710 may additionally or alternatively include other similar means for allowing computer programs or other instructions to be loaded into the computing device 1700 for execution. Such means may include, for example, a removable storage unit 1722 and an associated interface 1720. Examples of a removable storage unit 1722 and interface 1720 may include a USB flash drive and a USB interface, a program cartridge and cartridge interface (e.g. such as that found in video game console devices), a removable memory chip (e.g. an EPROM or PROM) and associated socket, and other exemplary removable storage units 1722 and interfaces 1720, which may enable software programs and/or data to be transferred between the removable storage unit 1722 and the computing device 1700.

The computing device 1700 also includes at least one communication interface 1724. The communication interface 1724 allows software programs and data to be transferred between computing device 1700 and external devices, via communication path 1726. In various aspects, the communication interface 1724 permits data to be transferred between the computing device 1700 and a data communication network, such as a public data or private data communication network. The communication interface 1724 may be used to exchange data between different computing devices 1700 that may together form part of an interconnected computer network. Examples of a communication interface 1724 may include a modem, a network interface (e.g. an Ethernet card), a communication port, an antenna with associated circuitry or the like. The communication interface 1724 may be configured as wired or wireless. Software and data transferred via the communication interface 1724 are in the form of signals, which can be electronic, electromagnetic, optical or other signals capable of being received by communication interface 1724. These signals are provided to the communication interface via the communication path 1726.

The computing device 1700 further may include a display interface 1702 configured to perform operations for rendering images to an associated display 1730, and an audio interface 1732 for performing operations for playing audio content via associated speaker(s) 1734.

As used herein, the term “computer program product” may refer, in part, to the removable storage unit 1718, the removable storage unit 1722, a hard disk installed in the hard disk drive 1712, or a carrier wave carrying software over the communication path 1726 (e.g. via a wireless link, or a cable) to the communication interface 1724. Computer readable storage media refers to any non-transitory tangible storage medium that provides recorded instructions and/or data to the computing device 1700 for execution and/or processing. Examples of such storage media include floppy disks, USB disk, magnetic tape, CD-ROM, DVD, Blu-rayTM Disc, a hard disk drive, a ROM or integrated circuit, USB memory, a magneto-optical disk, or a computer readable card such as a PCMCIA card or the like, whether or not such devices are internal or external of the computing device 1700. Examples of transitory or non-tangible computer readable transmission media that may also participate in the provision of software, application programs, instructions and/or data to the computing device 1700 include radio or infra-red transmission channels as well as a network connection to another computer or networked device, and the Internet or Intranets including e-mail transmissions and information recorded on websites and the like.

The computer programs (also termed computer program code/instruction) are stored in the main memory 1708 and/or the secondary memory 1710. Computer programs may also be received via the communication interface 1724. Such computer programs, when executed, enable the computing device 1700 to perform one or more aspects of the present disclosure afore discussed. In various aspects of the present disclosure, the computer programs, which when executed, enable the processor 1704 to perform aspect(s) of the present disclosure. Accordingly, such computer programs may represent (logic) controllers of the computing device 1700.

Software may be stored in a computer program product and loaded into the computing device 1700, using the removable storage drive 1714, the hard disk drive 1712, or the interface 1720. Alternatively, the computer program product may be downloaded directly onto the computing device 1700, via the communication path 1726. The software, when executed by the processor 1704, causes the computing device 1700 to perform aspects of the present disclosure.

It is to be understood that the computing device 1700 in FIG. 17 is presented merely by way of example. Hence, in some aspects, one or more features of the computing device 1700 may be omitted. Also, in other aspects, one or more features of the computing device 1700 may be combined together, or collocated. Additionally, in some aspects, one or more features of the computing device 1700 may be divided into one or more component parts.

It is to be appreciated that the elements illustrated in FIG. 17 may further function to provide means for performing the various functions of the disclosed method 200 in FIG. 2, as described in accordance with aspects of the present disclosure. Also, the term “computing device” 1600, 1700 may include or may refer to a mobile device, a wireless device, a remote device, a handheld device, a smartphone, a tablet computer, a laptop computer, a computer server, a computer terminal, a blade server, among other examples. The computing device 1600, 1700 described herein may be able to communicate with various types of devices, such as other computing devices 1600, 1700 that may sometimes act as relays, or work together under configuration to function as a computer cluster for performing high-performance computing.

All of the methods described herein describe possible implementations, and that the operations and the steps may be rearranged or otherwise modified and that other implementations are possible. Further, aspects from two or more of the methods, if applicable, may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (such as, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples”. The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but to be accorded the broadest scope consistent with the principles and novel features disclosed herein.

### EXAMPLES

The following examples are disclosed, in accordance with aspects of the present disclosure.

Example 1: A computer-implemented method for optimizing circuit design of a digital compute-in-memory (DCIM) macro, comprises: performing, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (Sac); performing, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and performing slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

Example 2: The method of example 1, wherein the structural parameters are provided by a designer of the DCIM macro.

Example 3: The method of any of examples 1-2, wherein the PPA constraints are defined by a designer of the DCIM macro.

Example 4: The method of any of examples 1-3, wherein performing rapid PPA evaluations on the first design to determine the optimal pipeline architecture includes a number and placement of pipeline stages to be assigned between the plurality of circuit cells.

Example 5: The method of example 4, wherein the structural parameters include input height (H), weight column (C), minimum data precision (P), and memory compute ratio (R).

Example 6: The method of any of examples 1-5, wherein the TSPC-FFs are configured as 11T dynamic circuit cells.

Example 7: The method of any of examples 1-6, further comprises: configuring, based on a process design kit (PDK), a DCIM cell library that includes template designs of SRAMs, full adders, and TSPC-FFs, wherein the PDK is provided by a semiconductor foundry, and includes template designs of standard circuit cells.

Example 8: The method of example 7, wherein the DCIM module library is configured based on the PDK and the DCIM cell library.

Example 9: The method of example 7, wherein the template designs of the SRAMs include a normal version and a low-power version of said SRAMs, in which relative to the normal version, the low-power version is characterized by a higher threshold voltage (Vₜ) and a cell structure that is configured with less energy consumption and a longer critical latency.

Example 10: The method of example 7, wherein the template designs of the full adders include a normal version and a low-power version of said full adders, in which relative to the normal version, the low-power version is characterized by a higher threshold voltage (Vₜ) and a cell structure that is configured with less energy consumption and a longer critical latency.

Example 11: The method of any of examples 1-10, wherein based on the third design, the DCIM macro is configured to operate at a maximum frequency range of between 1.03 GHz to 1.40 GHz.

Example 12: The method of any of examples 1-11, wherein based on the third design, the DCIM macro is to be fabricated by 28 nm CMOS node.

Example 13: The method of any of examples 1-12, further comprises: generating, based on the third design of the DCIM macro, a hierarchical schematic design.

Example 14: The method of any of examples 1-13, wherein the first design of the DCIM macro is a baseline design.

Example 15: A computing device for optimizing circuit design of a digital compute-in-memory (DCIM) macro, comprising: one or more memories having executable code; and one or more processors coupled to the one or more memories, and configured to execute the code to cause the device to: perform, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (Sac); perform, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and perform slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

Example 16: A computing device for optimizing circuit design of a digital compute-in-memory (DCIM) macro, comprising: means for performing, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture, wherein the plurality of circuit cells include a combination of a static random-access memory (SRAM), a bitwise-multiplier (MUL), an adder tree (AddT), and a shift-accumulator (Sac); means for performing, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and means for performing slack-power tuning, based on the second design, on non-critical stages of the DCIM macro defined by the optimal pipeline architecture to obtain a third design of the DCIM macro, which includes means for evaluating all combinations of lower power modules for use in the non-critical stages, based on latency and power consumption criteria, to permit identification of one combination that satisfy said latency and power consumption criteria for selection as the third design, wherein the latency criterion defines that a total latency configured for a combination is to be the largest possible, and which is less than or equal to the latency of a critical path in the determined optimal pipeline architecture, and wherein the power consumption criterion defines that energy consumption by a combination is to be the lowest possible.

Example 17: A non-transitory computer-readable medium comprising executable code, which when executed by a processor of a computing device, cause the device to perform the method of any of examples 1-14.

### REFERENCES

Y. He et al., “A 28 nm 38-to-102-TOPS/W 8b Multiply-Less Approximate Digital SRAM Compute-In-Memory Macro for Neural-Network Inference”, ISSCC, pp. 130-131, 2023. https://doi.org/10.1109/ISSCC42615.2023.10067305
A. Guo et al., “A 22 nm 64 kb Lightning-Like Hybrid Computing-in-Memory Macro with a Compressed Adder Tree and Analog-Storage Quantizers for Transformer and CNNs”, ISSCC, pp. 570-571, 2024. https://doi.org/10.1109/ISSCC49657.2024.10454278
P. Chen et al., “A 22 nm Delta-Sigma Computing-In-Memory (ΔΣCIM) SRAM Macro with Near-Zero-Mean Outputs and LSB-First ADCs Achieving 21.38TOPS/W for 8b-MAC Edge AI Processing”, ISSCC, pp. 140-141, 2023. https://doi.org/10.1109/ISSCC42615.2023.10067289
S. Hsieh et al., “A 70.85-86.27TOPS/W PVT-Insensitive 8b Word-Wise ACIM with Post Processing Relaxation”, ISSCC, pp. 136-137, 2023. https://doi.org/10.1109/ISSCC42615.2023.10067335
F. Tu et al., “MuITCIM: A 28 nm 2.24 uJ/Token Attention-Token-Bit Hybrid Sparse Digital CIM Based Accelerator for Multimodal Transformers”, ISSCC, pp. 248-249, 2023. https://doi.org/10.1109/ISSCC42615.2023.10067842
S. Kim et al., “DynaPlasia: An eDRAM In-Memory-Computing-Based Reconfigurable Spatial Accelerator with Triple-Mode Cell for Dynamic Resource Switching”, ISSCC, pp. 256-257, 2023. https://doi.org/10.1109/ISSCC42615.2023.1006735 2
H. Mori et al., “A 4 nm 6163-TOPS/W/b 4790-TOPS/mm2/b SRAM Based Digital-Computing-in-Memory Macro Supporting Bit-Width Flexibility and Simultaneous MAC and Weight Update”, ISSCC, pp. 132-133, 2023. https://doi.org/10.1109/ISSCC42615.2023.10067555
H. Fujiwara et al., “A 3 nm, 32.5TOPS/W, 55.0TOPS/mm2 and 3.78Mb/mm2 Fully-Digital Compute-in-Memory Macro Supporting INT12×INT12 with a Parallel-MAC Architecture and Foundry 6T-SRAM Bit Cell”, ISSCC, pp. 572-573, 2024. https://doi.org/10.1109/ISSCC49657.2024.10454556

What is claimed is:

1. A computer-implemented method for optimizing circuit design of a digital compute-in-memory (DCIM) macro, the method comprising:
performing, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture,
wherein the plurality of circuit cells include a combination of a static random-access memory (SRAM), a bitwise-multiplier (MUL), an adder tree (AddT), and a shift-accumulator (Sac);
performing, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and
performing slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design,
wherein the latency criterion defines that a total latency configured for a combination is to be the largest possible, and which is less than or equal to the latency of a critical path in the determined optimal pipeline architecture, and
wherein the power consumption criterion defines that energy consumption by a combination is to be the lowest possible.

2. The method of claim 1, wherein the structural parameters are provided by a designer of the DCIM macro.

3. The method of claim 1, wherein the PPA constraints are defined by a designer of the DCIM macro.

4. The method of claim 1, wherein performing rapid PPA evaluations on the first design to determine the optimal pipeline architecture includes determining a number and placement of pipeline stages to be assigned between the plurality of circuit cells.

5. The method of claim 4, wherein the structural parameters include input height (H), weight column (C), minimum data precision (P), and memory compute ratio (R).

6. The method of claim 1, wherein the TSPC-FFs are configured as 11T dynamic circuit cells.

7. The method of claim 1, further comprises:
configuring, based on a process design kit (PDK), a DCIM cell library that includes template designs of SRAMs, full adders, and TSPC-FFs,
wherein the PDK is provided by a semiconductor foundry, and includes template designs of standard circuit cells.

8. The method of claim 7, wherein the DCIM module library is configured based on the PDK and the DCIM cell library.

9. The method of claim 7, wherein the template designs of the SRAMs include a normal version and a low-power version of said SRAMs, in which relative to the normal version, the low-power version is characterized by a higher threshold voltage (Vₜ) and a cell structure configured with less energy consumption and a longer critical latency.

10. The method of claim 7, wherein the template designs of the full adders include a normal version and a low-power version of said full adders, in which relative to the normal version, the low-power version is characterized by a higher threshold voltage (Vₜ) and a cell structure configured with less energy consumption and a longer critical latency.

11. The method of claim 1, wherein based on the third design, the DCIM macro is configured to operate at a maximum frequency range of between 1.03 GHz to 1.40 GHz.

12. The method of claim 1, wherein based on the third design, the DCIM macro is to be fabricated by 28 nm CMOS node.

13. The method of claim 1, further comprises:
generating, based on the third design of the DCIM macro, a hierarchical schematic design.

14. The method of claim 1, wherein the first design of the DCIM macro is a baseline design.

15. A computing device for optimizing circuit design of a digital compute-in-memory (DCIM) macro, comprising:
one or more memories having executable code; and
one or more processors coupled to the one or more memories, and configured to execute the code to cause the device to:
perform, based on a DCIM macro template and structural parameters for the DCIM macro, design space exploration (DSE) to obtain a first design of the DCIM macro that is configured with no pipeline stages, and a plurality of circuit cells to be coupled via one or more pipeline stages to form a pipeline architecture,
wherein the plurality of circuit cells include a combination of a static random-access memory (SRAM), a bitwise-multiplier (MUL), an adder tree (AddT), and a shift-accumulator (Sac);
perform, based on power-performance-area (PPA) constraints and using a DCIM module library, rapid PPA evaluations on the first design to determine an optimal pipeline architecture for the DCIM macro to obtain a second design thereof, wherein a maxima of a point set on a Pareto boundary formed by the rapid PPA evaluations corresponds to indication of the optimal pipeline architecture, in which pipeline registers thereof are based on true single-phase clock (TSPC) flip-flops (TSPC-FFs); and
perform slack-power tuning, based on the second design, on non-critical stages of the DCIM macro defined by the optimal pipeline architecture to obtain a third design of the DCIM macro, which includes evaluating all combinations of lower power modules for use in the non-critical stages, based on latency and power consumption criteria, to permit identification of one combination that satisfy said latency and power consumption criteria for selection as the third design,
wherein the latency criterion defines that a total latency configured for a combination is to be the largest possible, and which is less than or equal to the latency of a critical path in the determined optimal pipeline architecture, and
wherein the power consumption criterion defines that energy consumption by a combination is to be the lowest possible.

16. A non-transitory computer-readable medium comprising executable code, which when executed by a processor of a computing device, cause the device to perform the method of claim 1.
